(19) United States
(12) Patent Application Publication
(10) Pub. No.: US 2026/0316558 A1
(43) Pub. Date: Oct. 15, 2026

(54) ACTUATOR AND REACTION FORCE APPLICATION DEVICE USING SAME

(71) Applicant: DENSO CORPORATION, Kariya-city (JP)

(72) Inventors: Rika IWATA, Kariya-city (JP); Noriyuki INAGAKI, Kariya-city (JP); Takuto KITA, Kariya-city (JP); Tetsuji YAMANAKA, Kariya-city (JP)

(21) Appl. No.: 19/465,057

(22) Filed: Jan. 30, 2026

Related U.S. Application Data
(63) Continuation of application No. PCT/JP2024/025727, filed on Jul. 18, 2024.

(30) Foreign Application Priority Data
Aug. 3, 2023 (JP) 2023-127338

(51) Int. Cl. B60K 26/02; G05G 5/03

(52) U.S. Cl. CPC B60K 26/021; G05G 5/03; B60K 2026/023; G05G 2505/00

(57) ABSTRACT

An output shaft is rotatable relative to a housing. An output gear is non-rotatable relative to the output shaft so as to rotate integrally with the output shaft. An intermediate shaft is rotatable relative to the housing. An intermediate gear is meshed with the output gear and a drive gear and is non-rotatable relative to the intermediate shaft. An urging member transmits an urging force to the output shaft, separately from a drive source, in a reaction force generating direction, in which the drive source generates the reaction force. An urging gear is meshed with the intermediate gear and is rotatable relative to the output shaft so as to rotate relative to the output gear. The urging member is disposed between the housing and the urging gear and transmits the urging force to the intermediate gear and the output gear via the urging gear.

### CROSS REFERENCE TO RELATED APPLICATIONS

This application is a continuation application of International Patent Application No. PCT/JP2024/025727 filed on Jul. 18, 2024, which designated the U.S. and claims the benefit of priority from Japanese Patent Application No. 2023-127338 filed on Aug. 3, 2023. The entire disclosures of all of the above applications are incorporated herein by reference.

### TECHNICAL FIELD

The present disclosure relates to an actuator and a reaction force application device using the same.

### BACKGROUND

Previously, a reaction force application device, which is configured to apply a reaction force against a pedal force of a human driver to a pedal of an accelerator device to be depressed by the human driver, has been known. The reaction force application device includes an actuator that is configured to generate the reaction force to be applied to the pedal.

### SUMMARY

According to the present disclosure, there is provided an actuator configured to output a reaction force against an external force applied in one direction. The actuator may include: a housing; a drive source which is disposed in the housing and includes a drive gear that is configured to output a drive force; and a speed reducer that is configured to reduce a speed of rotation outputted from the drive source as the drive force. The speed reducer may include: an output shaft that is rotatable relative to the housing; an output gear that is non-rotatable relative to the output shaft so as to rotate integrally with the output shaft; an intermediate shaft that is rotatable or non-rotatable relative to the housing; an intermediate gear that is meshed with the output gear and the drive gear and is non-rotatable or rotatable relative to the intermediate shaft; an urging member that is configured to transmit an urging force to the output shaft, separately from the drive source, in a reaction force generating direction, in which the drive source is configured to generate the reaction force; and an urging gear that is meshed with the intermediate gear and is rotatable relative to the output shaft so as to rotate relative to the output gear. The urging member may be disposed between the housing and the urging gear and may be configured to transmit the urging force to the intermediate gear and the output gear via the urging gear.

### BRIEF DESCRIPTION OF DRAWINGS

The drawings described herein are for illustrative purposes only of selected embodiments and not all possible implementations, and are not intended to limit the scope of the present disclosure.

FIG. 1 is a view showing an actuator of a first embodiment, a reaction force application device using the actuator, and an accelerator device to which the reaction force application device is applied.

FIG. 2 is a view showing the reaction force application device of the first embodiment.

FIG. 3 is a cross-sectional view showing the reaction force application device of the first embodiment.

FIG. 4 is a perspective view showing a drive source and a speed reducer of the actuator of the first embodiment.

FIG. 5 is a view showing a meshing portion of gears of the actuator according to the first embodiment.

FIG. 6 is a schematic cross-sectional view showing a part of the actuator of the first embodiment.

FIG. 7 is a schematic cross-sectional view showing the part of the actuator of the first embodiment.

FIG. 8 is a view showing a reaction force application device of a comparative example.

FIG. 9 is a cross-sectional view showing the reaction force application device of the comparative example.

FIG. 10 is a view showing a meshing portion of gears of an actuator of the comparative example.

FIG. 11 is a cross-sectional view showing a reaction force application device according to a second embodiment.

FIG. 12 is a cross-sectional view showing a reaction force application device according to a third embodiment.

FIG. 13 is a perspective view showing an output gear and an urging gear of an actuator of the third embodiment.

FIG. 14 is a view showing the output gear and the urging gear of the actuator of the third embodiment.

FIG. 15 is a cross-sectional view showing a reaction force application device according to a fourth embodiment.

FIG. 16 is a cross-sectional view showing an intermediate gear of an actuator of the fourth embodiment.

FIG. 17 is a cross-sectional view showing a reaction force application device according to a fifth embodiment.

FIG. 18 is a cross-sectional view showing a part of an actuator according to a sixth embodiment.

FIG. 19 is a cross-sectional view showing a part of an actuator according to a seventh embodiment.

FIG. 20 is a cross-sectional view showing a part of an actuator according to an eighth embodiment.

FIG. 21 is a cross-sectional view showing a part of an actuator according to a ninth embodiment.

### DETAILED DESCRIPTION

Previously, a reaction force application device, which is configured to apply a reaction force against a pedal force of a human driver to a pedal of an accelerator device to be depressed by the human driver, has been known.

The reaction force application device includes an actuator that is configured to generate the reaction force to be applied to the pedal.

In this actuator, a lever connected to a speed reducer is urged by a torsion spring so as to be constantly in contact with an accelerator pedal lever. Accordingly, when the accelerator is operated, internal gears are also driven in accordance with the operation of the pedal. In such a configuration, play caused by backlash of a gear, that is, looseness, may cause abnormal noise or delays in load transmission during operation.

Generally, scissors gears are known as gears that eliminate the backlash. However, they have a complex structure in which a spring that applies tension between coaxially arranged gears is provided. Therefore, if such gears are adopted in the actuator described above, the actuator may become larger, or its structure may become more complicated.

According to the present disclosure, there is provided an actuator configured to output a reaction force against an external force applied in one direction. The actuator includes a housing, a drive source and a speed reducer. The drive source is disposed in the housing and includes a drive gear that is configured to output a drive force. The speed reducer is configured to reduce a speed of rotation outputted from the drive source as the drive force.

The speed reducer includes an output shaft, an output gear, an intermediate shaft, an intermediate gear, an urging member and an urging gear. The output shaft is rotatable relative to the housing. The output gear is non-rotatable relative to the output shaft so as to rotate integrally with the output shaft.

The intermediate shaft is rotatable or non-rotatable relative to the housing. The intermediate gear is meshed with the output gear and the drive gear and is non-rotatable or rotatable relative to the intermediate shaft. The urging member is configured to transmit an urging force to the output shaft, separately from the drive source, in a reaction force generating direction, in which the drive source is configured to generate the reaction force.

The urging gear is meshed with the intermediate gear and is rotatable relative to the output shaft so as to rotate relative to the output gear. The urging member is disposed between the housing and the urging gear and is configured to transmit the urging force to the intermediate gear and the output gear via the urging gear.

In the present disclosure, the urging force of the urging member can generate a return force for the output shaft, and at the same time, can take up play between the intermediate gear and the output gear. In other words, the single urging member makes it possible to both generate the return force and take up the play between the gears. This makes it possible to suppress the generation of abnormal noise and delays in the load transmission caused by the play between the gears, all with the simple configuration.

Hereinafter, an actuator and a reaction force application device using the same according to various embodiments will be described with reference to the drawings. The same reference signs are given to substantially the same portions among the embodiments, and the redundant description thereof will be omitted for the sake of simplicity.

### First Embodiment

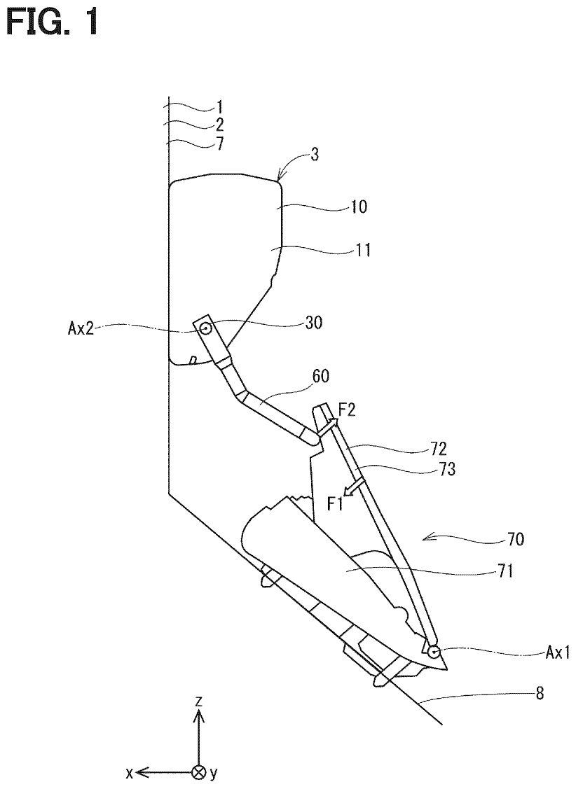

FIG. 1 shows an actuator, a reaction force application device using the actuator and an accelerator device using the reaction force application device according to the first embodiment.

The accelerator device 70 is installed on a vehicle (automobile) 1 to detect an accelerator opening degree corresponding to a rotational angle of a pedal 72 operated by a human driver (hereinafter referred to as a driver) of the vehicle and control a driving state of the vehicle 1. The accelerator device 70 adopts an accelerator-by-wire system and is not mechanically coupled to a throttle device of the vehicle 1. The accelerator device 70 transmits information regarding the accelerator opening degree corresponding to the rotational angle of the pedal 72 to an electronic control unit (hereinafter referred to as ECU) not shown in the drawing. The ECU controls the throttle device based on the accelerator opening degree transmitted from the accelerator device 70. As a result, the driving state of the vehicle 1 is controlled.

The reaction force application device 3 is installed on the vehicle 1 together with the accelerator device 70 and is configured to apply a reaction force F2 against a pedal force F1 of the driver to the pedal 72 of the accelerator device 70. The reaction force application device 3 is configured to provide a driver notification(s), such as a danger alert notification(s) and a fuel efficiency improvement notification(s), by applying the reaction force to the pedal 72 of the accelerator device 70. The reaction force application device 3 is also configured to convert the pedal 72 into a footrest by restricting the rotation of the pedal 72.

In FIG. 1, an x-axis indicates a traveling direction of the vehicle 1, and a y-axis indicates a vehicle width direction. Furthermore, a z-axis indicates a vertical upward direction. Hereinafter, unless otherwise specified, the shapes or configurations of the accelerator device 70 and the reaction force application device 3 in the installed state thereof on the vehicle 1 will be described. For example, “upper” or “upper side” means the upper or upper side in the state where the accelerator device 70 or the reaction force application device 3 is installed on the vehicle 1. In the present embodiment, a floor panel 2 has a wall surface 7, which is parallel to a y-z plane, and a wall surface 8, which is tilted relative to the wall surface 7.

The accelerator device 70 includes a pedal housing 71 and the pedal 72. The pedal housing 71 is installed on the floor panel 2 of the vehicle 1 by being fixed to the wall surface 8 of the floor panel 2 with, for example, mounting bolts.

The pedal 72 is rotatably supported by the pedal housing 71 so as to rotate around a rotational axis Ax1. The pedal 72 has a pad 73 that is configured to be depressed by the driver. An accelerator opening degree sensor (not shown) is installed at the inside of the pedal housing 71. The accelerator opening degree sensor detects the accelerator opening degree corresponding to the rotational angle of the pedal 72, which is rotated by the depressing operation of the driver, and then the accelerator opening degree sensor transmits the accelerator opening degree to the ECU. The rotational axis Ax1 is set to be perpendicular to the z-axis and the x-axis and parallel to the y-axis.

A pedal urging member (not shown) is installed at the inside of the pedal housing 71. The pedal 72 is urged in an accelerator closing direction by the pedal urging member. The pedal housing 71 has: one stopper that limits the rotation of the pedal 72 in the accelerator closing direction; and another stopper that limits the rotation of the pedal 72 in an accelerator opening direction. The pedal 72 is rotatable within a range which is from a contact position, where the pedal 72 contacts the one stopper, to another contact position, where the pedal 72 contacts the other stopper. FIG. 1 shows a state where the pedal 72 is in contact with the one stopper in the accelerator closing direction, i.e., is in an accelerator fully closed state.

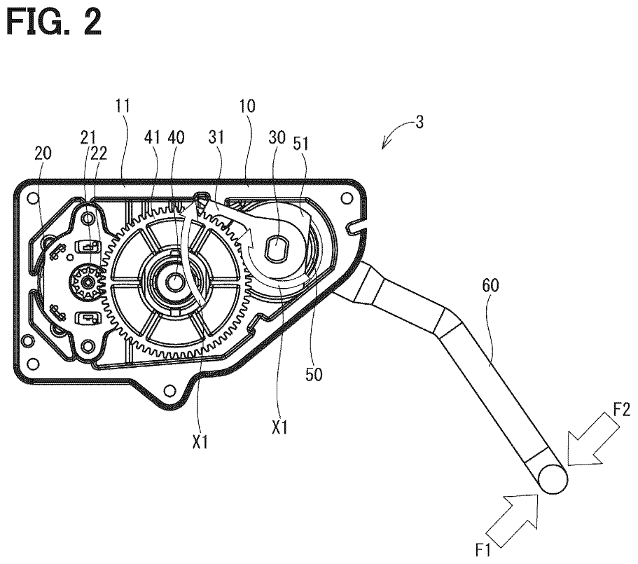

As shown in FIGS. 1 and 2, the reaction force application device 3 includes an actuator 10 and a load transmission member 60. The load transmission member 60 is non-rotatable relative to an output shaft 30 described later and is rotatable integrally with the output shaft 30. The load transmission member 60 contacts the pedal 72 and applies a reaction force to the pedal 72 in a return direction (hereinafter, the return direction of the pedal 72) in which the pedal 72 returns to its original position.

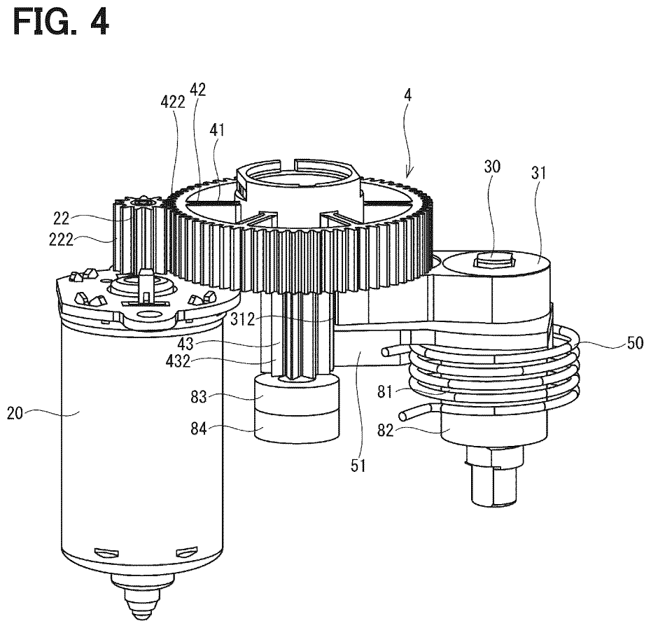

As shown in FIGS. 2, 3 and 4, the actuator 10 includes a housing 11, a drive source 20 and a speed reducer 4. The drive source 20 is disposed in the housing 11 and has a drive gear 22 that outputs a drive force. The speed reducer 4 is configured to reduce a speed of rotation outputted from the drive source 20 as the drive force and thereafter output the rotation.

The speed reducer 4 includes the output shaft 30, an output gear 31, an intermediate shaft 40, an intermediate gear 41, an urging member 50 and an urging gear 51. The output shaft 30 is rotatable relative to the housing 11. The output gear 31 is non-rotatable relative to the output shaft 30 so as to rotate integrally with the output shaft 30.

The intermediate shaft 40 is rotatable relative to the housing 11. The intermediate gear 41 is meshed with the output gear 31 and the drive gear 22 and is non-rotatable relative to the intermediate shaft 40. The urging member 50 is configured to transmit an urging force to the output shaft 30, separately from the drive source 20, in a reaction force generating direction, in which the drive source 20 is configured to generate the reaction force.

The urging gear 51 is meshed with the intermediate gear 41 and is rotatable relative to the output shaft 30 so as to rotate relative to the output gear 31. The urging member 50 is disposed between the housing 11 and the urging gear 51 and is configured to transmit the urging force to the intermediate gear 41 and the output gear 31 via the urging gear 51.

Hereinafter, the structure of the actuator 10 will be described in detail.

The housing 11 is mounted to the floor panel 2 of the vehicle 1 by being fixed to the wall surface 7 of the floor panel 2 with mounting bolts (not shown), for example. The housing 11 includes a housing main-body 12 and a cover 13. The housing main-body 12 is made of, for example, metal. The cover 13 is made of, for example, resin. When an opening of the housing main-body 12 and an opening of the cover 13 contact with each other, the housing main-body 12 and the cover 13 form a space therein to receive the members. The housing main-body 12 and the cover 13 are joined together by, for example, bolts (not shown).

The drive source 20 is, for example, an electric motor such as a DC motor, and is received in the housing 11. The drive source 20 can output torque as the drive force when the drive source 20 is energized. The ECU can control the energization of the drive source 20 to control an operation of the drive source 20.

The drive source 20 is disposed in the housing main-body 12 of the housing 11. The drive source 20 includes a shaft 21 and the drive gear 22. The shaft 21 is arranged such that one end portion of the shaft 21 is coupled to a rotor (not shown), and the shaft 21 is configured to output the drive force of the drive source 20. The drive gear 22 is mounted to the other end portion of the shaft 21. The drive gear 22 has a plurality of drive gear teeth 222 as external teeth on an outer peripheral wall of the drive gear 22.

The housing main-body 12 has an output shaft hole 121, an intermediate shaft hole 122 and a housing tubular portion 123. The output shaft hole 121 extends through the housing main-body 12. The intermediate shaft hole 122 extends through the housing main-body 12. The housing tubular portion 123 is formed in a tubular shape and extends from an outer periphery of the output shaft hole 121 toward the cover 13.

The actuator 10 includes a bearing 81, a bearing 82, a bearing 83 and a bearing 84. Each of the bearings 81-84 is a ball bearing. The bearings 81, 82 are installed in an inside of the housing tubular portion 123 and an inside of the output shaft hole 121 such that the bearings 81, 82 are arranged in the axial direction. The bearings 83, 84 are installed in an inside of the intermediate shaft hole 122 such that the bearings 83, 84 are arranged in the axial direction.

The output shaft 30 is provided on a rotational axis Ax2 and is supported by the bearings 81, 82 so as to be rotatable about the rotational axis Ax2. Accordingly, the output shaft 30 is rotatable relative to the housing 11.

The output gear 31 is formed in a plate shape and is made of, for example, metal. An output gear hole 311 is formed in the output gear 31. The output gear hole 311 extends through the output gear 31 in a plate thickness direction thereof. A cross-section of the output gear hole 311 and a cross-section of one end portion of the output shaft 30 are respectively formed in a non-circular shape, such as, for example, a D-cut shape or a double-flat shape. The output gear 31 is arranged such that the output gear hole 311 is fitted onto the one end portion of the output shaft 30. Thereby, the output gear 31 is non-rotatable relative to the output shaft 30 so as to rotate integrally with the output shaft 30. An opposite end portion of the output gear 31, which is opposite to the output gear hole 311, has a plurality of output gear teeth 312, which serve as external teeth and are arranged in a circumferential direction of the output shaft 30.

The intermediate shaft 40 is rotatably supported by the bearings 83, 84. Accordingly, the intermediate shaft 40 is rotatable relative to the housing 11.

The intermediate gear 41 is made of, for example, resin. The intermediate gear 41 includes an intermediate gear large-diameter portion 42 and an intermediate gear small-diameter portion 43. The intermediate gear large-diameter portion 42 is formed in, for example, a ring shape. The intermediate gear small-diameter portion 43 is formed integrally with the intermediate gear large-diameter portion 42 in one-piece such that the intermediate gear small-diameter portion 43 is formed in a tubular shape and extends from an inner periphery of the intermediate gear large-diameter portion 42. An intermediate gear hole 411 is formed inside the intermediate gear small-diameter portion 43.

The intermediate gear 41 is integrally molded with the intermediate shaft 40 in, for example, a state where the intermediate shaft 40 is disposed in the intermediate gear hole 411. Accordingly, the intermediate gear 41 is non-rotatable relative to the intermediate shaft 40.

A plurality of intermediate gear large-diameter teeth 422, which serve as external teeth, are formed at an outer periphery of the intermediate gear large-diameter portion 42. The intermediate gear large-diameter teeth 422 are configured to mesh with the drive gear teeth 222. A plurality of intermediate gear small-diameter teeth 432, which serve as external teeth, are formed at an outer peripheral wall of the intermediate gear small-diameter portion 43. The intermediate gear small-diameter teeth 432 are configured to mesh with the output gear teeth 312.

The urging member 50 is, for example, a helical coil spring, that is, a torsion spring. The urging member 50 is disposed on a radially outer side of the housing tubular portion 123.

The urging gear 51 is formed in a plate shape and is made of, for example, resin. An urging gear hole 511 is formed in the urging gear 51. The urging gear hole 511 extends through the urging gear 51 in a plate thickness direction thereof. An inner diameter of the urging gear hole 511 is larger than an outer diameter of the output shaft 30. The urging gear 51 is disposed between the output gear 31 and the bearing 81 such that the output shaft 30 is positioned inside the urging gear hole 511. Accordingly, the urging gear 51 is rotatable relative to the output gear 31 and the output shaft 30. Additionally, the urging gear 51 is axially movable relative to the output shaft 30 between the output gear 31 and the bearing 81.

An opposite end portion of the urging gear 51, which is opposite to the urging gear hole 511, has a plurality of urging gear teeth 512, which are arranged in the circumferential direction of the output shaft 30. The urging gear teeth 512 are configured to mesh with the intermediate gear small-diameter teeth 432.

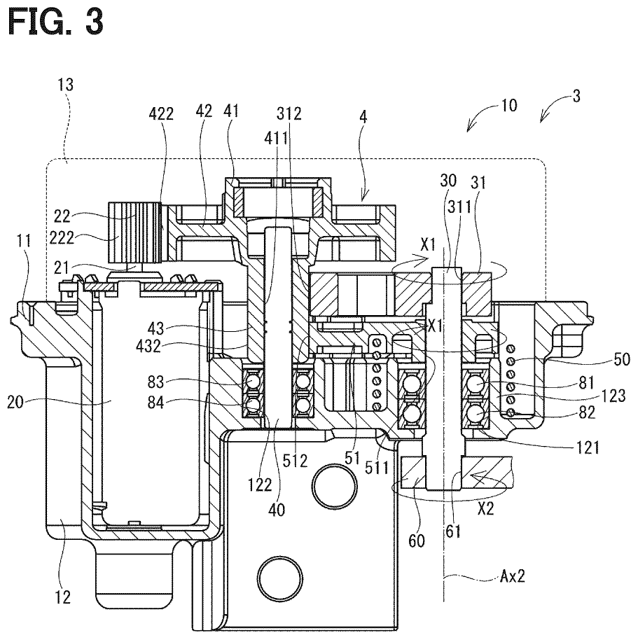

The urging member 50 is disposed between the housing main-body 12 and the urging gear 51 such that one end portion of the urging member 50 is locked to the housing main-body 12, and the other end portion of the urging member 50 is locked to the urging gear 51. The urging member 50 urges the urging gear 51 such that the urging gear 51 is rotated in the rotational direction X1, which is the rotational direction of the output gear 31, when the actuator 10 generates a reaction force in response to the drive force outputted from the drive source 20 (see FIG. 3). Accordingly, the urging member 50 can transmit the urging force to the output gear 31 via the intermediate gear 41 via the urging gear 51.

The load transmission member 60 is formed in a rod shape and is made of, for example, metal. A load transmission member hole 61 is formed in the load transmission member 60. The load transmission member hole 61 is formed in one end portion of the load transmission member 60. A cross-section of the load transmission member hole 61 and a cross-section of the other end portion of the output shaft 30 are respectively formed in a non-circular shape, such as, for example, a double-flat shape or a D-cut shape. The load transmission member 60 is arranged such that the load transmission member hole 61 is fitted onto the other end portion of the output shaft 30. Thereby, the load transmission member 60 is non-rotatable relative to the output shaft 30 so as to rotate integrally with the output shaft 30.

The other end portion of the load transmission member 60 is configured to contact the pedal 72 of the accelerator device 70. When the drive source 20 is activated, the drive force is outputted from the drive gear 22. Therefore, the intermediate gear 41 is rotated by the drive force, and thereby the output gear 31 and the output shaft 30 are rotated in the rotational direction X1. Thus, the reaction force F2 is applied from the load transmission member 60 to the pedal 72. When the driver's pedal force F1 acts as an external force on the other end portion of the load transmission member 60, the load transmission member 60 and the output shaft 30 are rotated in a rotational direction X2 (see FIG. 3).

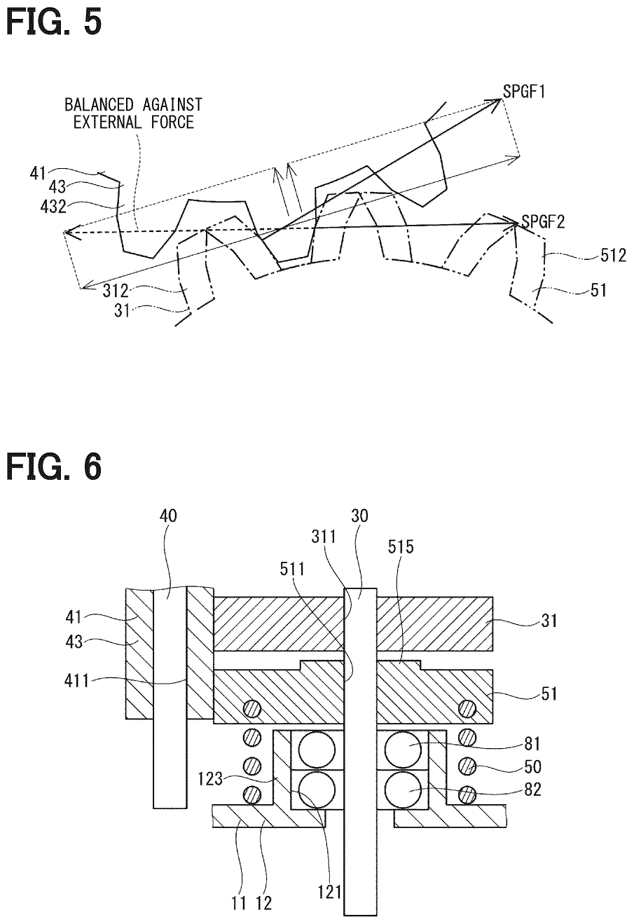

As shown in FIG. 5, an urging force SPGF1 from the urging member 50 acts on the intermediate gear small-diameter teeth 432 via the urging gear teeth 512. Additionally, an urging force SPGF2 from the urging member 50 acts on the output gear teeth 312 via the intermediate gear 41. The urging force SPGF1 and the urging force SPGF2 counteract the external force acting on the intermediate gear small-diameter teeth 432 to achieve a balance. A restoring force for returning the output gear 31 to its initial position is generated by the backlash elimination through the urging force resulting from the load transmission and the urging force SPGF2 of the urging member 50 transmitted via the intermediate gear 41.

By arranging the urging gear 51 coaxially with the output gear 31, the overall size can be made more compact compared to a case where the urging gear 51 is arranged on an axis different from that of the output gear 31. Further, since the load in the rotational direction on the output gear 31 is canceled during the meshing, the load acting in the direction perpendicular to the axis of the output gear 31, that is, the load acting in the direction to tilt the axis, can be reduced. As a result, abnormal wear and operating failures between gears can be suppressed.

As shown in FIG. 6, the urging gear 51 has a projection 515 that projects from a surface of the urging gear 51 toward the output gear 31 in a predetermined range of the surface of the urging gear 51 located radially outward of the output shaft 30. The projection 515 is configured to contact the output gear 31. Therefore, by providing clearance at the tooth tip side, that is, the outer peripheral side of the urging gear 51 and the output gear 31, and by providing the sliding contact portion between the urging gear 51 and the output gear 31 in the vicinity of the output shaft 30, sliding losses can be reduced.

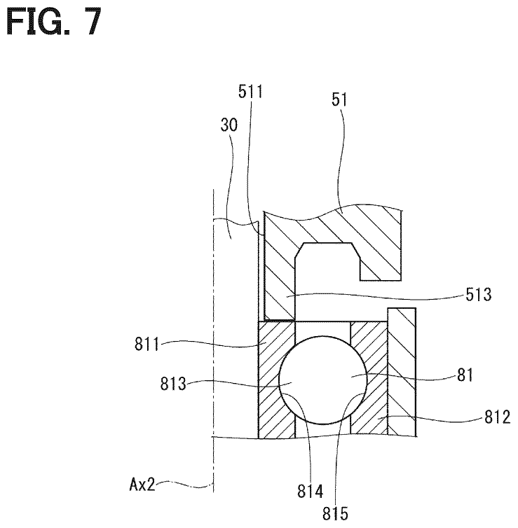

As shown in FIG. 7, the bearing 81 has an inner race 811, an outer race 812 and a plurality of balls 813. The inner race 811 and the outer race 812 are respectively formed in a tubular shape. The outer race 812 is disposed on a radially outer side of the inner race 811. An outer peripheral wall of the inner race 811 has a bearing groove 814, which is formed in a ring shape. An inner peripheral wall of the outer race 812 has a bearing groove 815, which is formed in a ring shape. The balls 813 are held between the inner race 811 and the outer race 812 such that the balls 813 are rotatable along the bearing groove 814 and the bearing groove 815. As a result, the inner race 811 and the outer race 812 can smoothly rotate relative to each other. Moreover, since the balls 813 are retained between the bearing groove 814 and the bearing groove 815, axial relative movement between the inner race 811 and the outer race 812 beyond a predetermined amount is restricted.

An inner peripheral wall of the inner race 811 of the bearing 81 is fitted to an outer peripheral wall of the output shaft 30 such that the inner race 811 is non-rotatable relative to the output shaft 30. An outer peripheral wall of the outer race 812 is fitted into an inner peripheral wall of the housing tubular portion 123 of the housing main-body 12 such that the outer race 812 is non-rotatable relative to the housing tubular portion 123.

The urging gear 51 has an urging gear tubular extension 513. The urging gear tubular extension 513 is formed in a tubular shape and extends from the urging gear hole 511 toward the bearing 81. An end surface of the urging gear tubular extension 513, which faces the bearing 81, is configured to contact an end surface of the inner race 811 of the bearing 81, which faces the urging gear 51. In other words, the end portion of the urging gear 51, which faces the bearing 81, is configured to contact only the inner race 811 of the bearing 81.

Although the urging gear 51 is rotatable relative to the output shaft 30, the amount of relative rotation of the urging gear 51 relative to the output shaft 30 is relatively small compared to the amount of relative rotation of the urging gear 51 relative to the housing tubular portion 123 of the housing 11 or the outer race 812 of the bearing 81. Therefore, by using the inner race 811, which rotates integrally with the output shaft 30, as the contact portion for the urging gear 51, the loss of urging force due to sliding friction can be significantly reduced.

Next, an actuator according to a comparative example will be described and compared with the present embodiment.

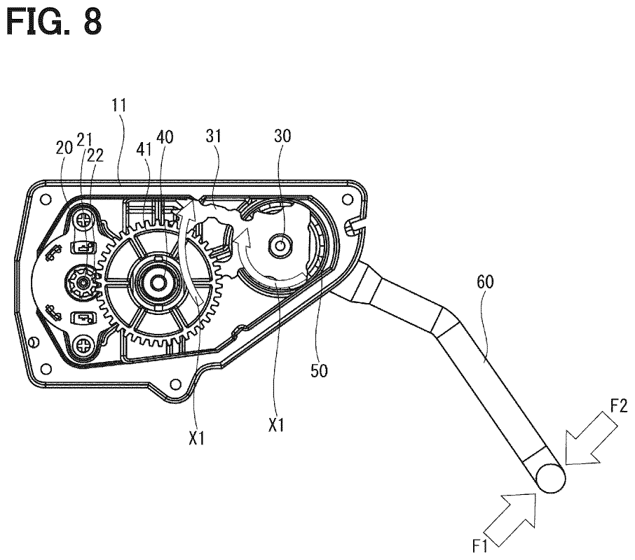

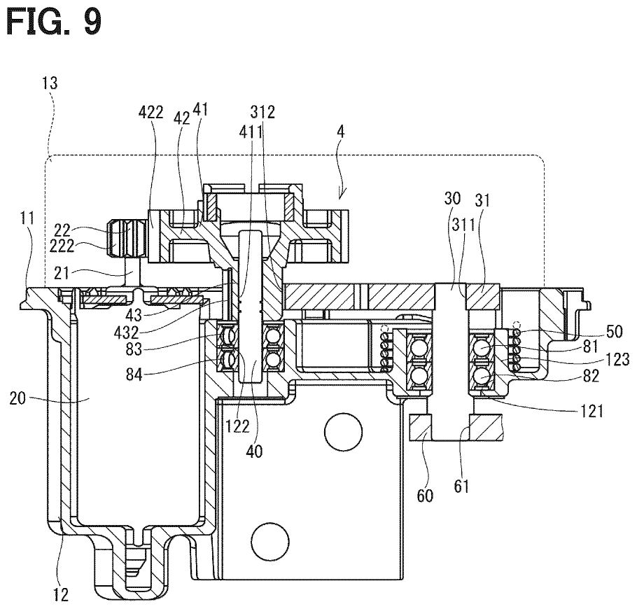

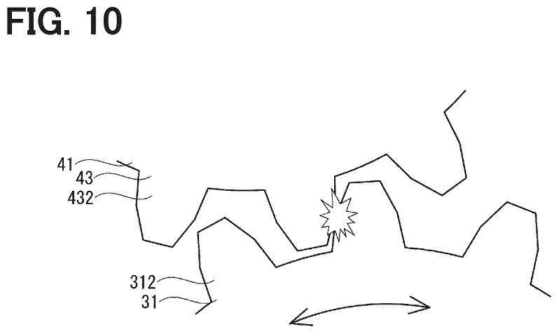

As shown in FIGS. 8 and 9, the actuator of the comparative example does not have the urging gear 51. The urging member 50 urges the output gear 31 in a direction toward an initial position to return it to the initial position. As shown in FIG. 10, in the actuator of the comparative example, backlash causes play between the intermediate gear small-diameter teeth 432 and the output gear teeth 312. Therefore, the play may cause abnormal noise due to collision between the teeth or a delay in load transmission.

On the other hand, in the present embodiment, each corresponding one of the intermediate gear small-diameter teeth 432 is held in a state where the intermediate gear small-diameter tooth 432 is sandwiched between the corresponding urging gear tooth 512 and the corresponding output gear tooth 312 due to the urging force of the urging member 50. Therefore, the play caused by backlash is taken up, and thereby the generation of abnormal noise and delays in load transmission can be suppressed (see FIG. 5).

As described above, in the present embodiment, the urging member 50 is configured to transmit the urging force to the output shaft 30, separately from the drive source 20, in the reaction force generating direction, in which the drive source 20 is configured to generate the reaction force.

The urging gear 51 is meshed with the intermediate gear 41 and is rotatable relative to the output shaft 30 so as to rotate relative to the output gear 31. The urging member 50 is disposed between the housing 11 and the urging gear 51 and is configured to transmit the urging force to the intermediate gear 41 and the output gear 31 via the urging gear 51.

In the present embodiment, the urging force of the urging member 50 can generate a return force for the output shaft 30, and at the same time, can take up the play between the intermediate gear 41 and the output gear 31. In other words, the single urging member 50 makes it possible to both generate the return force and take up the play between the gears. This makes it possible to suppress generation of abnormal noise and a delay in the load transmission caused by the play between the gears, all with the simple configuration.

Furthermore, the actuator 10 of the present embodiment includes the bearing 81 that is installed to the housing 11 to rotatably support the output shaft 30. The urging gear 51 is axially movable relative to the output shaft 30 between the output gear 31 and the bearing 81. Therefore, the movement and the position of the urging gear 51 in the axial direction of the output shaft 30 are restricted by the output gear 31 and the bearing 81.

Additionally, the urging gear 51 has the projection 515 that projects toward the output gear 31 from the center portion of the surface facing the output gear 31, so as to be able to contact the output gear 31. Therefore, by providing clearance at the tooth tip side, that is, the outer peripheral side of the urging gear 51 and the output gear 31, and by providing the sliding contact portion between the urging gear 51 and the output gear 31 in the vicinity of the output shaft 30, the sliding losses can be reduced.

According to the present embodiment, there is provided the reaction force application device 3 configured to apply the reaction force against the pedal force of the human driver to the pedal 72 of the accelerator device 70 to be depressed by the human driver. The reaction force application device 3 includes the actuator 10 and the load transmission member 60 described above. The load transmission member 60 is non-rotatable relative to the output shaft 30 and is rotatable integrally with the output shaft 30. The load transmission member 60 contacts the pedal 72 and applies the reaction force to the pedal 72 in the return direction of the pedal 72.

The actuator 10 makes it possible to suppress generation of abnormal noise and a delay in the load transmission caused by the play between the gears. Therefore, even when the human driver depresses the pedal 72, the generation of abnormal noise and a sense of operational discomfort caused by the play from the backlash can be suppressed.

### Second Embodiment

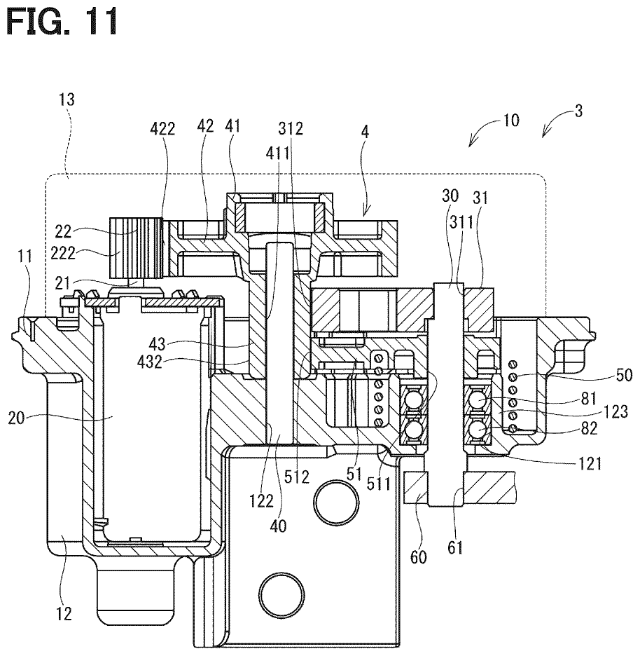

FIG. 11 shows an actuator according to the second embodiment. The second embodiment differs from the first embodiment with respect to the structure around the intermediate shaft 40.

In the present embodiment, the bearing 83 and the bearing 84 are not provided. One end portion of the intermediate shaft 40 is fitted into the intermediate shaft hole 122 of the housing main-body 12 and is non-rotatable relative to the housing 11. An inner diameter of the intermediate gear hole 411 is larger than an outer diameter of the intermediate shaft 40. Therefore, the intermediate gear 41 is rotatable relative to the intermediate shaft 40.

As described above, in the present embodiment, the intermediate shaft 40 is non-rotatable relative to the housing 11. Furthermore, the intermediate gear 41 is rotatable relative to the intermediate shaft 40. Even with this configuration, similar to the first embodiment, the generation of abnormal noise and the delay in the load transmission due to the play between the gears can be suppressed.

### Third Embodiment

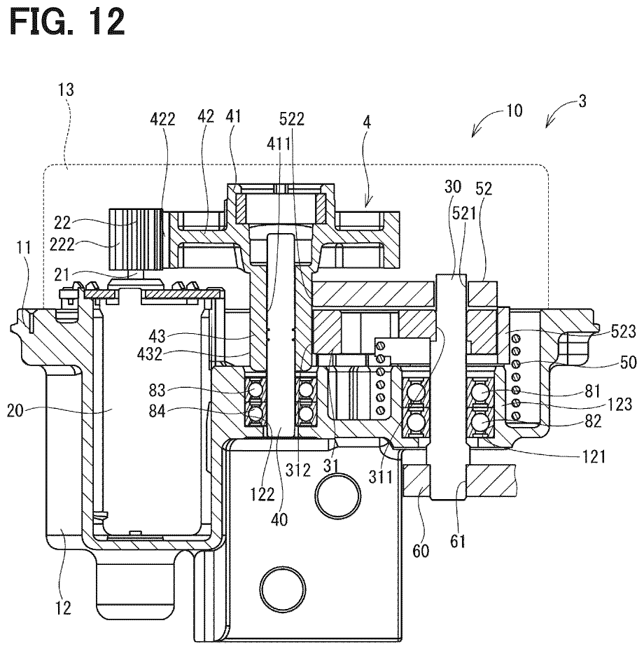

FIG. 12 shows an actuator according to the third embodiment. The third embodiment differs from the first embodiment with respect to the arrangement of the urging gear.

As shown in FIGS. 12, 13 and 14, in the present embodiment, the speed reducer 4 includes an urging gear 52. An urging gear hole 521 is formed in the urging gear 52. The urging gear 52 is disposed on a side of the output gear 31 which is opposite to the bearing 81. An end portion of the output shaft 30 is inserted through the urging gear hole 521. The urging gear 52 is rotatable relative to the output shaft 30 and the output gear 31.

An opposite end portion of the urging gear 52, which is opposite to the urging gear hole 521, has a plurality of urging gear teeth 522, which are arranged in the circumferential direction of the output shaft 30. The urging gear teeth 522 are configured to mesh with the intermediate gear small-diameter teeth 432.

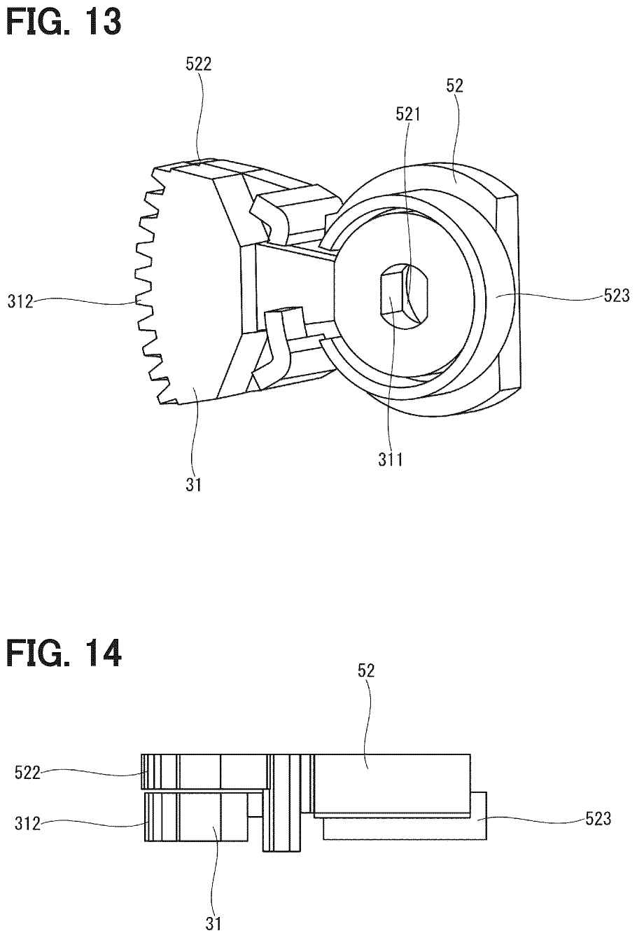

The urging gear 52 has an urging gear tubular portion 523. The urging gear tubular portion 523 is formed in a tubular shape such that a circumferential part of the urging gear tubular portion 523 is cut out, and the urging gear tubular portion 523 surrounds the periphery of the end portion of the output gear 31, which faces the output gear hole 311 (see FIG. 13).

The other end portion of the urging member 50 is locked to the urging gear 52. Similar to the first embodiment, the urging member 50 urges the urging gear 52 such that the urging gear 52 is rotated in the same direction as that of the output gear 31 when the actuator 10 generates the reaction force in response to the drive force outputted from the drive source 20.

As described above, in the present embodiment, the urging gear 52 is disposed on the side of the output gear 31 which is opposite to the bearing 81. Even with this configuration, similar to the first embodiment, the generation of abnormal noise and the delay in the load transmission due to the play between the gears can be suppressed.

### Fourth Embodiment

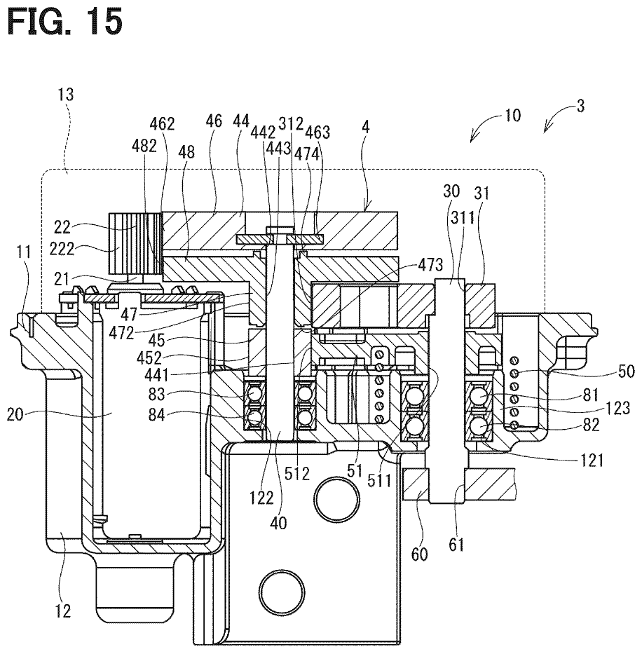

FIG. 15 shows an actuator according to the fourth embodiment. The fourth embodiment differs from the first embodiment with respect to the configuration of the intermediate gear.

In the present embodiment, an intermediate gear 44 is provided. The intermediate gear 44 includes a first main-intermediate gear 45, a second main-intermediate gear 46, a first sub-intermediate gear 47 and a second sub-intermediate gear 48. The first main-intermediate gear 45 is meshed with the urging gear 51. The second main-intermediate gear 46 is configured to rotate integrally with the first main-intermediate gear 45. The first sub-intermediate gear 47 is meshed with the output gear 31. The second sub-intermediate gear 48 is configured to rotate integrally with the first sub-intermediate gear 47.

The first main-intermediate gear 45 and the second main-intermediate gear 46, and the first sub-intermediate gear 47 and the second sub-intermediate gear 48 are mounted on the intermediate shaft 40 such that the first main-intermediate gear 45 and the second main-intermediate gear 46 are rotatable relative to the first sub-intermediate gear 47 and the second sub-intermediate gear 48. The second main-intermediate gear 46 and the second sub-intermediate gear 48 are meshed with the drive gear 22. The urging force from the urging member 50 can be transmitted to the output gear 31 via the urging gear 51, the first main-intermediate gear 45, the second main-intermediate gear 46, the drive gear 22, the second sub-intermediate gear 48 and the first sub-intermediate gear 47 in this order.

The first main-intermediate gear 45 is positioned in an axial direction of the intermediate shaft 40 such that the first main-intermediate gear 45 is meshed only with the urging gear 51 without interfering with the output gear 31. The first sub-intermediate gear 47 is positioned in the axial direction of the intermediate shaft 40 such that the first sub-intermediate gear 47 is meshed only with the output gear 31 without interfering with the urging gear 51.

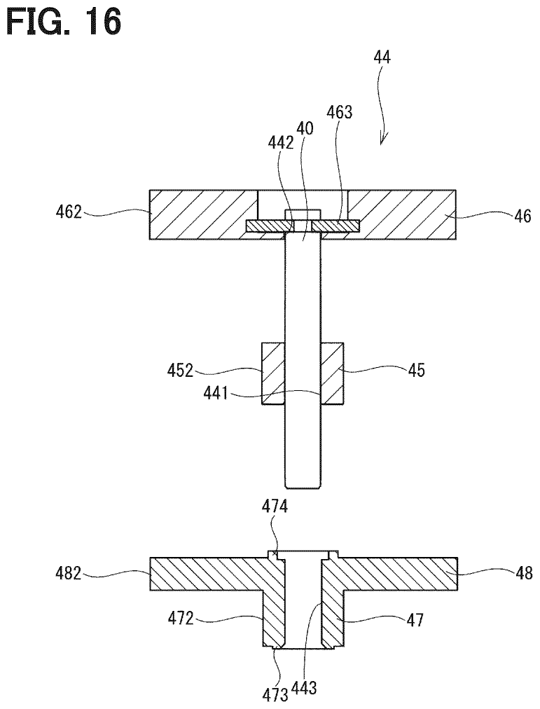

More specifically, the first main-intermediate gear 45 and the second main-intermediate gear 46 are formed as separate bodies from, for example, resin. The first main-intermediate gear 45 is formed in a tubular shape and has an intermediate gear hole 441 formed therein. The intermediate gear hole 441 of the first main-intermediate gear 45 is fitted onto the intermediate shaft 40 such that the first main-intermediate gear 45 is non-rotatable relative to the intermediate shaft 40 (see FIGS. 15 and 16). The second main-intermediate gear 46 is formed in a ring plate shape and has an intermediate gear hole 442 formed therein. The second main-intermediate gear 46 is fixed by a gear fixing member 463 in a state where the intermediate gear hole 442 is fitted onto the end portion of the intermediate shaft 40 such that the second main-intermediate gear 46 is non-rotatable relative to the intermediate shaft 40.

A plurality of first main-intermediate gear teeth 452, which serve as external teeth, are formed at an outer peripheral wall of the first main-intermediate gear 45. The first main-intermediate gear teeth 452 are configured to mesh with the urging gear teeth 512. A plurality of second main-intermediate gear teeth 462, which serve as external teeth, are formed at an outer periphery of the second main-intermediate gear 46. The second main-intermediate gear teeth 462 are configured to mesh with the drive gear teeth 222.

The first sub-intermediate gear 47 and the second sub-intermediate gear 48 are formed in one-piece from, for example, resin. The first sub-intermediate gear 47 is formed in a tubular shape and has an intermediate gear hole 443 formed therein. The second sub-intermediate gear 48 is shaped in a ring plate shape such that the second sub-intermediate gear 48 extends radially outward from one end portion of the first sub-intermediate gear 47.

A plurality of first sub-intermediate gear teeth 472, which serve as external teeth, are formed at an outer peripheral wall of the first sub-intermediate gear 47. The first sub-intermediate gear teeth 472 are configured to mesh with the output gear teeth 312. A plurality of second sub-intermediate gear teeth 482, which serve as external teeth, are formed at an outer periphery of the second sub-intermediate gear 48. The second sub-intermediate gear teeth 482 are configured to mesh with the drive gear teeth 222.

An intermediate gear tubular extension 473 and an intermediate gear tubular extension 474 are formed on the first sub-intermediate gear 47. The intermediate gear tubular extension 473 is formed in a tubular shape and projects from one end surface of the first sub-intermediate gear 47. The intermediate gear tubular extension 474 is formed in a tubular shape and projects from the other end surface of the first sub-intermediate gear 47.

The first sub-intermediate gear 47 and the second sub-intermediate gear 48, which are formed integrally in one-piece, are disposed between the first main-intermediate gear 45 and the second main-intermediate gear 46 on a radially outer side of the intermediate shaft 40 (see FIG. 15). An inner diameter of the intermediate gear hole 443 is larger than the outer diameter of the intermediate shaft 40. Therefore, the first sub-intermediate gear 47 and the second sub-intermediate gear 48 are rotatable relative to the first main-intermediate gear 45 and the second main-intermediate gear 46 and are also movable relative to the first main-intermediate gear 45 and the second main-intermediate gear 46 in the axial direction. An end surface of the intermediate gear tubular extension 473 is configured to contact an end surface of the first main-intermediate gear 45, which faces the second main-intermediate gear 46. An end surface of the intermediate gear tubular extension 474 is configured to contact an end surface of the second main-intermediate gear 46, which faces the first main-intermediate gear 45.

The sliding loss can be reduced by forming the intermediate gear tubular extension 473 and the intermediate gear tubular extension 474 on the first sub-intermediate gear 47, and by providing, in the vicinity of the intermediate shaft 40, a sliding portion between the first sub-intermediate gear 47 and the first main-intermediate gear 45 and a sliding portion between the first sub-intermediate gear 47 and the second main-intermediate gear 46.

Hereinafter, a method for assembling the intermediate gear 44 onto the intermediate shaft 40 will now be described.

First, the first main-intermediate gear 45 is provided on the intermediate shaft 40 by insert molding or press-fitting. Here, in a case where the first main-intermediate gear 45 is made of metal, the first main-intermediate gear 45 may be formed integrally in one-piece with the intermediate shaft 40, or the first main-intermediate gear 45 may be provided on the intermediate shaft 40 by the press-fitting.

Next, the intermediate shaft 40 is inserted through the intermediate gear hole 443 of the first sub-intermediate gear 47 and second sub-intermediate gear 48 which are formed integrally in one-piece. Thereafter, the gear fixing member 463, which is insert-molded in the second main-intermediate gear 46, is secured to the end portion of the intermediate shaft 40 by, for example, press-fitting, caulking, or welding. This completes the assembly of the intermediate gear 44 onto the intermediate shaft 40.

FIG. 16 shows, in respective cross-sectional views, the first sub-intermediate gear 47 and the second sub-intermediate gear 48, which are formed integrally in one-piece, and the intermediate shaft 40, the first main-intermediate gear 45 and the second main-intermediate gear 46 in a state where the first sub-intermediate gear 47 and the second sub-intermediate gear 48 are not assembled thereto.

With the above configuration, the urging force from the urging member 50 is transmitted to the output gear 31 via the urging gear 51, the first main-intermediate gear 45, the second main-intermediate gear 46, the drive gear 22, the second sub-intermediate gear 48 and the first sub-intermediate gear 47 in this order. This makes it possible to eliminate the backlash between the gears.

As described above, in the present embodiment, the intermediate gear 44 is provided. The intermediate gear 44 includes the first main-intermediate gear 45, the second main-intermediate gear 46, the first sub-intermediate gear 47 and the second sub-intermediate gear 48. The first main-intermediate gear 45 is meshed with the urging gear 51. The second main-intermediate gear 46 is configured to rotate integrally with the first main-intermediate gear 45. The first sub-intermediate gear 47 is meshed with the output gear 31. The second sub-intermediate gear 48 is configured to rotate integrally with the first sub-intermediate gear 47.

The first main-intermediate gear 45 and the second main-intermediate gear 46, and the first sub-intermediate gear 47 and the second sub-intermediate gear 48 are mounted on the intermediate shaft 40 such that the first main-intermediate gear 45 and the second main-intermediate gear 46 are rotatable relative to the first sub-intermediate gear 47 and the second sub-intermediate gear 48. The second main-intermediate gear 46 and the second sub-intermediate gear 48 are meshed with the drive gear 22. The urging force from the urging member 50 is transmittable to the output gear 31 via the urging gear 51, the first main-intermediate gear 45, the second main-intermediate gear 46, the drive gear 22, the second sub-intermediate gear 48 and the first sub-intermediate gear 47 in this order.

The first main-intermediate gear 45 is positioned in the axial direction of the intermediate shaft 40 such that the first main-intermediate gear 45 is meshed only with the urging gear 51 without interfering with the output gear 31. The first sub-intermediate gear 47 is positioned in the axial direction of the intermediate shaft 40 such that the first sub-intermediate gear 47 is meshed only with the output gear 31 without interfering with the urging gear 51.

As in the present embodiment, even in the case where the reduction gear stage is added, the backlash at the meshing portion of the added gear can be taken up by the urging force of the urging member 50. Therefore, it is possible to suppress the generation of abnormal noise and the delay in the load transmission caused by the play between the gears.

### Fifth Embodiment

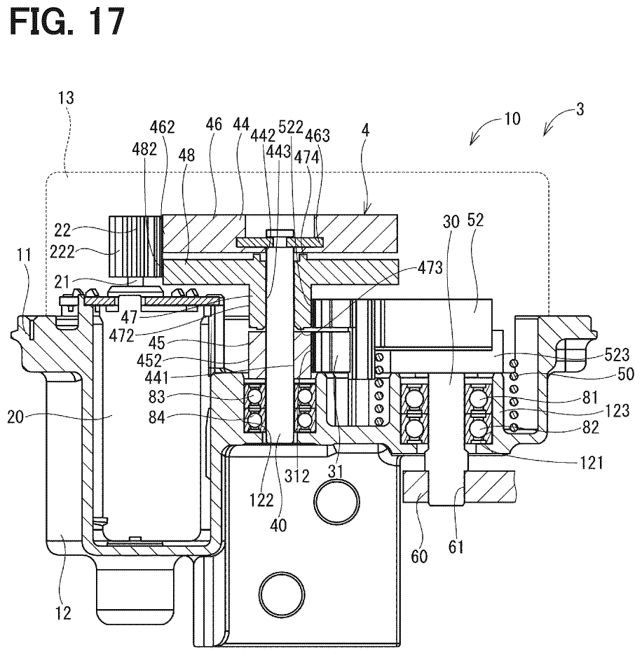

FIG. 17 shows an actuator according to the fifth embodiment. The fifth embodiment differs from the fourth embodiment with respect to the arrangement of the urging gear.

In the present embodiment, the speed reducer 4 includes the urging gear 52 discussed in the third embodiment. Similar to the third embodiment, the urging gear 52 is disposed on the side of the output gear 31 which is opposite to the bearing 81. The other end portion of the urging member 50 is locked to the urging gear 52.

The urging gear teeth 522 are configured to mesh with the first sub-intermediate gear teeth 472. The first sub-intermediate gear 47 is meshed with the urging gear 52. The output gear teeth 312 are configured to mesh with the first main intermediate gear teeth 452. The first main-intermediate gear 45 is meshed with the output gear 31.

In the present embodiment, the urging force from the urging member 50 is transmittable to the output gear 31 via the urging gear 52, the first sub-intermediate gear 47, the second sub-intermediate gear 48, the drive gear 22, the second main-intermediate gear 46 and the first main-intermediate gear 45 in this order.

The first main-intermediate gear 45 is positioned in the axial direction of the intermediate shaft 40 such that the first main-intermediate gear 45 is meshed only with the output gear 31 without interfering with the urging gear 52. The first sub-intermediate gear 47 is positioned in the axial direction of the intermediate shaft 40 such that the first sub-intermediate gear 47 is meshed only with the urging gear 52 without interfering with the output gear 31.

As described above, in the present embodiment, the intermediate gear 44 is provided. The intermediate gear 44 includes the first main-intermediate gear 45, the second main-intermediate gear 46, the first sub-intermediate gear 47 and the second sub-intermediate gear 48. The first main-intermediate gear 45 is meshed with the output gear 31. The second main-intermediate gear 46 is configured to rotate integrally with the first main-intermediate gear 45. The first sub-intermediate gear 47 is meshed with the urging gear 52. The second sub-intermediate gear 48 is configured to rotate integrally with the first sub-intermediate gear 47.

The first main-intermediate gear 45 and the second main-intermediate gear 46, and the first sub-intermediate gear 47 and the second sub-intermediate gear 48 are mounted on the intermediate shaft 40 such that the first main-intermediate gear 45 and the second main-intermediate gear 46 are rotatable relative to the first sub-intermediate gear 47 and the second sub-intermediate gear 48. The second main-intermediate gear 46 and the second sub-intermediate gear 48 are meshed with the drive gear 22. The urging force from the urging member 50 is transmittable to the output gear 31 via the urging gear 51, the first sub-intermediate gear 47, the second sub-intermediate gear 48, the drive gear 22, the second main-intermediate gear 46 and the first main-intermediate gear 45 in this order.

The first main-intermediate gear 45 is positioned in the axial direction of the intermediate shaft 40 such that the first main-intermediate gear 45 is meshed only with the output gear 31 without interfering with the urging gear 52. The first sub-intermediate gear 47 is positioned in the axial direction of the intermediate shaft 40 such that the first sub-intermediate gear 47 is meshed only with the urging gear 52 without interfering with the output gear 31.

As in the present embodiment, even in the case where the reduction gear stage is added, and the arrangement of the urging gear 52 and the output gear 31 is changed, the backlash at the meshing portion of the added gear can be taken up by the urging force of the urging member 50. Therefore, it is possible to suppress the generation of abnormal noise and the delay in the load transmission caused by the play between the gears.

### Sixth Embodiment

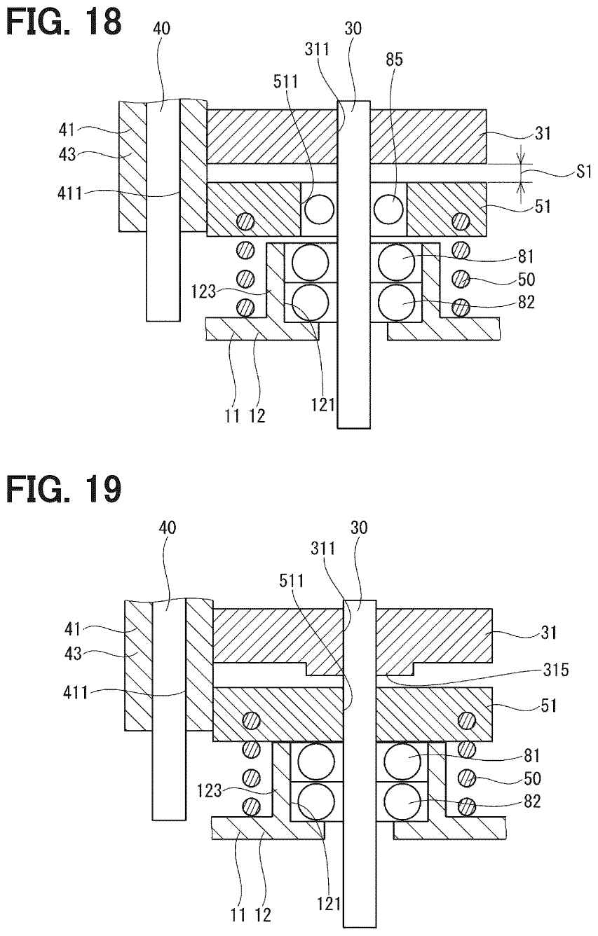

FIG. 18 shows a part of an actuator according to the sixth embodiment. The sixth embodiment differs from the first embodiment with respect to the configuration around the urging gear 51.

In the present embodiment, the urging gear 51 is arranged such that movement of the urging gear 51 relative to the output shaft 30 in the axial direction is restricted, thereby forming a gap S1 between the urging gear 51 and the output gear 31.

More specifically, the actuator 10 further includes a bearing 85. The bearing 85 is, for example, a ball bearing and has the same configuration as the bearing 81. An inner peripheral wall of an inner race of the bearing 85 is fitted to the outer peripheral wall of the output shaft 30 such that the inner race is non-rotatable relative to the output shaft 30. An outer peripheral wall of an outer race of the bearing 85 is fitted to an inner peripheral wall of the urging gear hole 511 such that the outer race is non-rotatable relative to the urging gear 51. Thereby, movement of the urging gear 51 relative to the output shaft 30 and the output gear 31 in the axial direction is restricted such that the movement of the urging gear 51 does not exceed a predetermined amount. Therefore, the urging gear 51 and the output gear 31 are always spaced from each other, and the gap S1 is constantly maintained between the urging gear 51 and the output gear 31.

As described above, in the present embodiment, the urging gear 51 is arranged such that the movement of the urging gear 51 relative to the output shaft 30 in the axial direction is restricted, thereby forming the gap S1 between the urging gear 51 and the output gear 31. Therefore, the output gear 31 and the urging gear 51 do not contact each other, and thereby it is possible to reduce the loss of the urging force caused by friction between the output gear 31 and the urging gear 51.

### Seventh Embodiment

FIG. 19 shows a part of an actuator according to the seventh embodiment. The seventh embodiment differs from the first embodiment with respect to the configuration of the output gear 31 and the urging gear 51.

In the present embodiment, the urging gear 51 does not have the projection 515 discussed in the first embodiment.

In the present embodiment, the output gear 31 has a projection 315 that projects from a surface of the output gear 31 toward the urging gear 51 in a predetermined range of the surface of the output gear 31 located radially outward of the output shaft 30. The projection 315 is configured to contact the urging gear 51. Therefore, by providing clearance at the tooth tip side, that is, the outer peripheral side of the urging gear 51 and the output gear 31, and by providing the sliding contact portion between the urging gear 51 and the output gear 31 in the vicinity of the output shaft 30, the sliding losses can be reduced.

### Eighth Embodiment

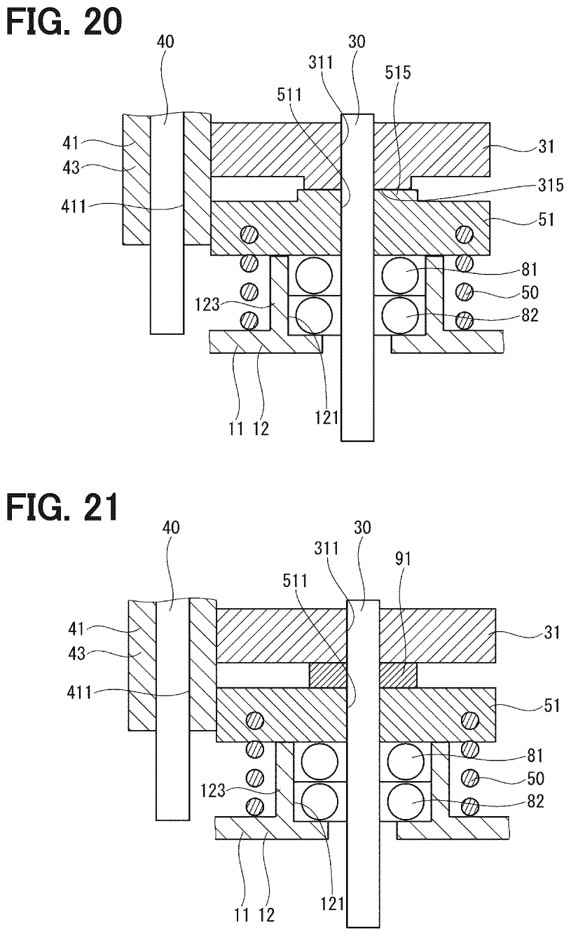

FIG. 20 shows a part of an actuator according to the eighth embodiment. The eighth embodiment differs from the first embodiment with respect to the configuration of the output gear 31.

In the present embodiment, the output gear 31 has the projection 315 that projects from the surface of the output gear 31 toward the urging gear 51 in the predetermined range of the surface of the output gear 31 located radially outward of the output shaft 30. The projection 315 is configured to contact the urging gear 51. An end surface of the projection 315 is configured to contact an end surface of the projection 515. Therefore, by providing clearance at the tooth tip side, that is, the outer peripheral side of the urging gear 51 and the output gear 31, and by providing the sliding contact portion between the urging gear 51 and the output gear 31 in the vicinity of the output shaft 30, the sliding losses can be reduced.

### Ninth Embodiment

FIG. 21 shows a part of an actuator according to the ninth embodiment. The ninth embodiment differs from the first embodiment with respect to the configuration of the urging gear 51.

In the present embodiment, the urging gear 51 does not have the projection 515 discussed in the first embodiment.

The actuator 10 of the present embodiment further includes a spacer 91. The spacer 91 is disposed between the output gear 31 and the urging gear 51.

More specifically, the spacer 91 is formed in an annular shape. The spacer 91 is disposed between the output gear 31 and the urging gear 51 on the radially outer side of the output shaft 30. One end surface of the spacer 91 is configured to contact the surface of the output gear 31 facing the urging gear 51 at a predetermined range of the surface of the output gear 31 located radially outward of the output shaft 30. The other end surface of the spacer 91 is configured to contact the surface of the urging gear 51 facing the output gear 31 at a predetermined range of the surface of the urging gear 51 located radially outward of the output shaft 30.

### Other Embodiments

In the first embodiment, the intermediate shaft is rotatable relative to the housing, and the intermediate gear is non-rotatable relative to the intermediate shaft. Furthermore, in the second embodiment, the intermediate shaft is non-rotatable relative to the housing, and the intermediate gear is rotatable relative to the intermediate shaft. In another embodiment, the intermediate shaft may be rotatable relative to the housing, and the intermediate gear may be rotatable relative to the intermediate shaft.

Furthermore, in another embodiment, the wall surface of the floor panel of the vehicle, to which the reaction force application device and the accelerator device are installed, is not necessarily formed parallel to the y-z plane. That is, the wall surface of the floor panel may be formed at any angle relative to the vehicle.

Furthermore, the actuator of the present disclosure may be applied to a device other than the reaction force application device. Furthermore, the reaction force application device and the accelerator device according to the present disclosure may also be applied to vehicles other than the automobiles.

The features of the present disclosure are as follows.

### Disclosure 1

According to disclosure 1, there is provided an actuator configured to output a reaction force against an external force applied in one direction, the actuator comprising:
a housing;
a drive source which is disposed in the housing and includes a drive gear that is configured to output a drive force; and
a speed reducer that is configured to reduce a speed of rotation outputted from the drive source as the drive force, wherein:
the speed reducer includes:
   an output shaft that is rotatable relative to the housing;
   an output gear that is non-rotatable relative to the output shaft so as to rotate integrally with the output shaft;
   an intermediate shaft that is rotatable or non-rotatable relative to the housing;
   an intermediate gear that is meshed with the output gear and the drive gear and is non-rotatable or rotatable relative to the intermediate shaft;
   an urging member that is configured to transmit an urging force to the output shaft, separately from the drive source, in a reaction force generating direction, in which the drive source is configured to generate the reaction force; and
   an urging gear that is meshed with the intermediate gear and is rotatable relative to the output shaft so as to rotate relative to the output gear; and
the urging member is disposed between the housing and the urging gear and is configured to transmit the urging force to the intermediate gear and the output gear via the urging gear.

### Disclosure 2

According to disclosure 2, there is provided the actuator according to disclosure 1, wherein the urging gear is configured such that axial movement of the urging gear relative to the output shaft is limited so as to form a gap between the urging gear and the output gear.

### Disclosure 3

According to disclosure 3, there is provided the actuator according to disclosure 1, comprising a bearing that is installed to the housing to rotatably support the output shaft, wherein:
the urging gear is disposed between the output gear and the bearing and is configured to axially move relative to the output shaft.

### Disclosure 4

According to disclosure 4, there is provided the actuator according to disclosure 3, wherein at least one of the urging gear and the output gear has a projection that projects from a surface of the at least one of the urging gear and the output gear toward another one of the urging gear and the output gear in a predetermined range of the surface located radially outward of the output shaft, wherein the projection is configured to contact the another one of the urging gear and the output gear.

### Disclosure 5

According to disclosure 5, there is provided the actuator according to disclosure 3, comprising a spacer that is disposed between the output gear and the urging gear.

### Disclosure 6

According to disclosure 6, there is provided the actuator according to any one of disclosures 1 to 5, wherein:
the intermediate gear includes:
   a first main-intermediate gear that is meshed with the urging gear;
   a second main-intermediate gear that is configured to rotate integrally with the first main-intermediate gear;
   a first sub-intermediate gear that is meshed with the output gear; and
   a second sub-intermediate gear that is configured to rotate integrally with the first sub-intermediate gear;
the first main-intermediate gear and the second main-intermediate gear, and the first sub-intermediate gear and the second sub-intermediate gear are mounted on the intermediate shaft such that the first main-intermediate gear and the second main-intermediate gear are rotatable relative to the first sub-intermediate gear and the second sub-intermediate gear;
the second main-intermediate gear and the second sub-intermediate gear are meshed with the drive gear;
the urging force of the urging member is transmittable to the output gear via the urging gear, the first main-intermediate gear, the second main-intermediate gear, the drive gear, the second sub-intermediate gear and the first sub-intermediate gear in this order;
the first main-intermediate gear is positioned in an axial direction of the intermediate shaft such that the first main-intermediate gear is meshed only with the urging gear without interfering with the output gear; and
the first sub-intermediate gear is positioned in the axial direction of the intermediate shaft such that the first sub-intermediate gear is meshed only with the output gear without interfering with the urging gear.

### Disclosure 7

According to disclosure 7, there is provided the actuator according to any one of disclosures 1 to 5, wherein:
the intermediate gear includes:
   a first main-intermediate gear that is meshed with the output gear;
   a second main-intermediate gear that is configured to rotate integrally with the first main-intermediate gear;
   a first sub-intermediate gear that is meshed with the urging gear; and
   a second sub-intermediate gear that is configured to rotate integrally with the first sub-intermediate gear;
the first main-intermediate gear and the second main-intermediate gear, and the first sub-intermediate gear and the second sub-intermediate gear are mounted on the intermediate shaft such that the first main-intermediate gear and the second main-intermediate gear are rotatable relative to the first sub-intermediate gear and the second sub-intermediate gear;
the second main-intermediate gear and the second sub-intermediate gear are meshed with the drive gear;
the urging force of the urging member is transmittable to the output gear via the urging gear, the first sub-intermediate gear, the second sub-intermediate gear, the drive gear, the second main-intermediate gear and the first main-intermediate gear in this order;
the first main-intermediate gear is positioned in an axial direction of the intermediate shaft such that the first main-intermediate gear is meshed only with the output gear without interfering with the urging gear; and
the first sub-intermediate gear is positioned in the axial direction of the intermediate shaft such that the first sub-intermediate gear is meshed only with the urging gear without interfering with the output gear.

### Disclosure 8

According to disclosure 8, there is provided a reaction force application device configured to apply a reaction force against a pedal force of a human driver to a pedal of an accelerator device to be depressed by the human driver, the reaction force application device comprising:
the actuator according to any one of disclosures 1 to 7; and
a load transmission member that is non-rotatable relative to the output shaft so as to rotate integrally with the output shaft, wherein:
the load transmission member is configured to contact the pedal and apply the reaction force to the pedal in a return direction of the pedal.

As described above, the present disclosure is not limited to the embodiments described above and can be implemented in various forms without departing from the spirit of the present disclosure.

The present disclosure has been described with reference to the embodiments. However, the present disclosure is not limited to the above embodiments and the structures described therein. The present disclosure also includes various variations and variations within the equivalent range. Also, various combinations and forms, as well as other combinations and forms that include only one element, more, or less, are within the scope and ideology of the present disclosure.

What is claimed is:

1. An actuator configured to output a reaction force against an external force applied in one direction, the actuator comprising:
a housing;
a drive source which is disposed in the housing and includes a drive gear that is configured to output a drive force; and
a speed reducer that is configured to reduce a speed of rotation outputted from the drive source as the drive force, wherein:
the speed reducer includes:
an output shaft that is rotatable relative to the housing;
an output gear that is non-rotatable relative to the output shaft so as to rotate integrally with the output shaft;
an intermediate shaft that is rotatable or non-rotatable relative to the housing;
an intermediate gear that is meshed with the output gear and the drive gear and is non-rotatable or rotatable relative to the intermediate shaft;
an urging member that is configured to transmit an urging force to the output shaft, separately from the drive source, in a reaction force generating direction, in which the drive source is configured to generate the reaction force; and
an urging gear that is meshed with the intermediate gear and is rotatable relative to the output shaft so as to rotate relative to the output gear; and
the urging member is disposed between the housing and the urging gear and is configured to transmit the urging force to the intermediate gear and the output gear via the urging gear.

2. The actuator according to claim 1, wherein the urging gear is configured such that axial movement of the urging gear relative to the output shaft is limited so as to form a gap between the urging gear and the output gear.

3. The actuator according to claim 1, comprising a bearing that is installed to the housing to rotatably support the output shaft, wherein:
the urging gear is disposed between the output gear and the bearing and is configured to axially move relative to the output shaft.

4. The actuator according to claim 3, wherein at least one of the urging gear and the output gear has a projection that projects from a surface of the at least one of the urging gear and the output gear toward another one of the urging gear and the output gear in a predetermined range of the surface located radially outward of the output shaft, wherein the projection is configured to contact the another one of the urging gear and the output gear.

5. The actuator according to claim 3, comprising a spacer that is disposed between the output gear and the urging gear.

6. The actuator according to claim 1, wherein:
the intermediate gear includes:
a first main-intermediate gear that is meshed with the urging gear;
a second main-intermediate gear that is configured to rotate integrally with the first main-intermediate gear;
a first sub-intermediate gear that is meshed with the output gear; and
a second sub-intermediate gear that is configured to rotate integrally with the first sub-intermediate gear;
the first main-intermediate gear and the second main-intermediate gear, and the first sub-intermediate gear and the second sub-intermediate gear are mounted on the intermediate shaft such that the first main-intermediate gear and the second main-intermediate gear are rotatable relative to the first sub-intermediate gear and the second sub-intermediate gear;
the second main-intermediate gear and the second sub-intermediate gear are meshed with the drive gear;
the urging force of the urging member is transmittable to the output gear via the urging gear, the first main-intermediate gear, the second main-intermediate gear, the drive gear, the second sub-intermediate gear and the first sub-intermediate gear in this order;
the first main-intermediate gear is positioned in an axial direction of the intermediate shaft such that the first main-intermediate gear is meshed only with the urging gear without interfering with the output gear; and
the first sub-intermediate gear is positioned in the axial direction of the intermediate shaft such that the first sub-intermediate gear is meshed only with the output gear without interfering with the urging gear.

7. The actuator according to claim 1, wherein:
the intermediate gear includes:
a first main-intermediate gear that is meshed with the output gear;
a second main-intermediate gear that is configured to rotate integrally with the first main-intermediate gear;
a first sub-intermediate gear that is meshed with the urging gear; and
a second sub-intermediate gear that is configured to rotate integrally with the first sub-intermediate gear;
the first main-intermediate gear and the second main-intermediate gear, and the first sub-intermediate gear and the second sub-intermediate gear are mounted on the intermediate shaft such that the first main-intermediate gear and the second main-intermediate gear are rotatable relative to the first sub-intermediate gear and the second sub-intermediate gear;
the second main-intermediate gear and the second sub-intermediate gear are meshed with the drive gear;
the urging force of the urging member is transmittable to the output gear via the urging gear, the first sub-intermediate gear, the second sub-intermediate gear, the drive gear, the second main-intermediate gear and the first main-intermediate gear in this order;
the first main-intermediate gear is positioned in an axial direction of the intermediate shaft such that the first main-intermediate gear is meshed only with the output gear without interfering with the urging gear; and
the first sub-intermediate gear is positioned in the axial direction of the intermediate shaft such that the first sub-intermediate gear is meshed only with the urging gear without interfering with the output gear.

8. A reaction force application device configured to apply a reaction force against a pedal force of a human driver to a pedal of an accelerator device to be depressed by the human driver, the reaction force application device comprising:
the actuator according to claim 1; and
a load transmission member that is non-rotatable relative to the output shaft so as to rotate integrally with the output shaft, wherein:
the load transmission member is configured to contact the pedal and apply the reaction force to the pedal in a return direction of the pedal.
